(19) United States
(12) Patent Application Publication
(10) Pub. No.: US 2026/0276383 A1
(43) Pub. Date: Sep. 17, 2026

(54) METHOD OF DETERMINING NAVIGATION DATA BY MEANS OF A GYROMETRIC DEVICE AND CORRESPONDING GYROMETRIC DEVICE

(71) Applicant: THALES, Meudon (FR)

(72) Inventors: Warody LOMBARDI, VALENCE (FR); Sebastien LEGOLL, VALENCE (FR); Nicolas Jean-Marc Frédéric VERCIER, VALENCE (FR)

(21) Appl. No.: 19/566,286

(22) Filed: Mar. 13, 2026

(30) Foreign Application Priority Data
Mar. 14, 2025 (FR) 2502558FR

(51) Int. Cl. G01C 19/5776; G01C 21/18; G01C 25/00

(52) U.S. Cl. CPC G01C 19/5776; G01C 21/18; G01C 25/00

(57) ABSTRACT

A method for determining navigation data includes: providing a calculator of a gyrometric device with at least one Fourier series of an error term modeling at least one defect of a gyrometer of the gyrometric device, a function of an angular position of the vibrating element; selecting at least one frequency range based on a plurality of amplitudes and respective frequencies of the Fourier series; determining a band-pass filter and continuous white noise to be provided at the input of the band-pass filter to obtain filtered noise at the output; determining a model of the error made on a measurement of the gyrometer based on the filtered noise; and determining the navigation data based on the determined model and at least one measurement of the gyrometer.

### CROSS-REFERENCE TO RELATED APPLICATIONS

This application is a U.S. non-provisional application claiming the benefit of French Application No. FR 25 02558, filed on Mar. 14, 2025, which is incorporated herein by reference in its entirety.

### BACKGROUND OF THE DISCLOSURE

### Field of the Disclosure

The present invention relates to a method for determining navigation data by means of a gyrometric device comprising a calculator and a gyrometer as well as the corresponding gyrometric device.

### Description of Related Art

A Coriolis Vibratory Gyroscope (CVG) makes it possible to measure the component along an axis, called the sensitivity axis of the CVG, of an instantaneous rotation speed vector of a reference frame linked to a sensor housing relative to an inertial reference frame.

The CVG comprises for this purpose a vibrating element of the gyroscope capable of vibrating relative to the housing. The measurement is carried out thanks to the effects of the Coriolis inertial force exerted on the vibrating element.

The vibrating element of a CVG is capable of vibrating in two coplanar vibration directions, called the drive mode direction and the detection mode direction, the work of the Coriolis force allowing a transfer of mechanical energy between the two directions.

The sensitivity axis of the CVG is orthogonal to the plane of the drive mode and detection mode directions.

For the measurements, the vibrating element is excited in the drive mode direction at its resonance frequency by the excitation system. The amplitude of the vibrations in the drive mode is kept constant by means of a voltage control system applied to the excitation system. Any variations in the resonance frequency, particularly related to temperature variations of the vibrating element, are monitored by means of a frequency control system.

Gyrometric measurements are affected by errors related to the intrinsic defects of the CVG.

Among these defects, we can mention the stiffness or damping anisotropies of the vibrating element, defects in the excitation control electronics or the position detection electronics of the vibrating element, defects in the reference electrical voltage for excitation, etc.

Gyrometric measurements are integrated to calculate the attitude of the reference frame linked to the gyroscope housing relative to another reference frame (for example, an inertial reference frame). They can also be combined with accelerometric measurements. The integration of these gyrometric and accelerometric measurements then makes it possible to calculate the speed and position of the housing linked to the gyroscope.

Errors in gyrometric measurements can cause an error increasing over time in the calculation of navigation data, such as the attitude, speed, and/or position of the housing.

Such errors may necessitate more or less frequent recalibration of the CVG.

To proceed with this recalibration, it is known to hybridize an inertial navigation system comprising the CVG with information from the detection of a particular event, for example, the detection of immobility of the gyroscope housing, or information from another sensor, for example, information from a satellite positioning system.

In such hybrid systems, inertial measurement data from the inertial navigation system and information from the detection of a particular event and/or another sensor are compared by means of an estimation module, this estimation module being able to implement, for example, a Kalman filter or a constant gain filter.

Hybridized navigation data are provided at the output of the estimation module and possibly used to recalibrate the inertial navigation system.

It is necessary to have a model providing an upper bound of the errors on the inertial measurements and in particular gyrometric measurements, in order to perform the hybridization of the inertial navigation system comprising the CVG with information from another sensor or from the detection of a particular event.

Among the errors of vibrating gyrometers, particularly axisymmetric vibrating gyrometers, some are called harmonic because they are proportional to cosine or sine functions of an integer multiple angle of the angle characterizing the position of the drive mode in the reference frame linked to the housing.

The modeling of these harmonic errors is complex because the number of harmonics to be modeled can be high and the amplitudes of these harmonics are generally variable over time.

The document C. I. Chen et al., “Extended Real Model of Kalman Filter for Time-Varying Harmonics Estimation,” in IEEE Transactions on Power Delivery, vol. 25, no. 1, pp. 17-Jan. 26, 2010, doi: 10.1109/TPWRD.2009.2035217 describes a method for modeling harmonic errors by means of a Kalman filter, the state vector of the Kalman filter comprising for each harmonic a component corresponding to the respective amplitude and a component corresponding to the respective phase.

The dimension of the corresponding state vector is therefore high, and this method is consequently costly in terms of memory and computation time.

One aim of the invention is therefore to propose a method for determining navigation data by means of a gyrometric device, this method comprising the modeling of a harmonic-type defect of a vibrating gyrometer of the gyrometric device, this method being reliable while being less costly in terms of time and/or memory than prior art methods.

### BRIEF SUMMARY OF THE DISCLOSURE

To this end, the invention aims at a method for determining navigation data by means of a gyrometric device comprising a calculator and a gyrometer, the gyrometer comprising a housing and a vibrating element, able to vibrate relative to the housing, the method comprising:
a) providing the calculator with at least one Fourier series of an error term modeling at least one defect of the gyrometer, said defect being a function of an angular position of the vibrating element in a reference frame linked to the housing;
b) selecting at least one frequency range based on a plurality of amplitudes and respective frequencies of said Fourier series;
c) determining a band-pass filter and continuous white noise to be provided at the input of the band-pass filter to obtain filtered noise at the output of the band-pass filter, such that:
   a bandwidth of the filter contains said frequency range and contains none of the respective frequencies of said Fourier series that are not in said frequency range, and
   in the bandwidth, the integral of a power spectral density of the filtered noise is greater than or equal to the sum of the squares of the amplitudes of the components of said Fourier series in this same bandwidth;
d) determining a model of the error made on a measurement performed with the gyrometer based on said filtered noise; and
e) determining navigation data based on said determined model and at least one measurement performed by the gyrometer.

To this end, the method according to the invention comprises the decomposition into a Fourier series of the gyrometer defect to be modeled, in order to identify the frequencies of the defect harmonics and their amplitudes.

As previously indicated, these amplitudes can be variable over time. The provision of the Fourier series decomposition can in this case be based on data from the gyrometer manufacturer and/or comprise the acquisition of measurements made during a prior calibration of the gyrometer, the measurements being sufficiently numerous to estimate an upper bound of the amplitude of each harmonic, this upper bound then being provided in the Fourier decomposition.

Instead of focusing on precisely describing these harmonics as is done in prior art methods, the error made on the measurement is modeled in the method according to the invention based on continuous white noise filtered by a band-pass filter.

For this, at least one frequency range wherein harmonics have a significant amplitude is determined based on the Fourier series decomposition, the bandwidth of the band-pass filter being chosen to encompass this frequency range.

The filtered noise obtained after filtering the continuous white noise by the band-pass forms an envelope of the harmonics that are comprised in the bandwidth of the filter.

The filtered noise therefore represents the harmonics in the bandwidth of the filter. In other words, the filtered noise encompasses these true defects but without taking into account the detail of each harmonic in a way that both does not underestimate the error made and limits the cost in terms of time and memory of the method.

The method according to the invention therefore allows a gain in memory and time during its implementation, without underestimating the true error made on the measurement.

Depending on the desired accuracy, the bandwidth of the filter can be chosen to be more or less wide and/or several filters with different bandwidths can be combined.

According to other advantageous aspects of the invention, the method comprises one or more of the following features, taken individually or according to all technically possible combinations:
the navigation data comprise:
hybridized navigation data, the method comprising in this case the receipt by the calculator of additional data, which comprise acceleration and/or speed and/or position and/or attitude data provided by an additional data sensor and/or data relating to the state of motion of the gyrometer housing, and the use of these additional data for the determination of said hybridized navigation data, and/or
inertial navigation data and respective error standard deviations, these data and these standard deviations being formed from the measurement performed with the gyrometer and a standard deviation of an error made on this measurement determined by means of said determined model;
the band-pass filter and the continuous white noise are chosen so that, in the bandwidth, the integral of the power spectral density of the filtered noise is equal to the sum of the squares of the amplitudes of the components of said Fourier series in this same bandwidth;
the determination of said error model comprises the implementation of the band-pass filter by means of a state propagation model and the determination of the filtered noise and/or a variance of the filtered noise; —the state propagation model is represented by the following model:

$$\{ \begin{matrix}\dot{u} ( t ) = [ \begin{matrix}0 & 1 \\ - {( 2 π {f}_{0} )}^{2} & - \frac{2 π {f}_{0}}{{Q}_{F}}\end{matrix} ] u ( t ) + [ \begin{matrix}0 \\ 1\end{matrix} ] w ( t ) \\ x ( t ) = [ \begin{matrix}0 & {H}_{0} \frac{2 π {f}_{0}}{{Q}_{F}}\end{matrix} ] u ( t )\end{matrix}$$

wherein:
u(t) denotes a 2-dimensional state vector of the state propagation model
w(t) denotes the continuous white noise at the input of the band-pass filter,
x(t) denotes the filtered noise obtained at the output of the band-pass filter,
f₀ denotes a resonance frequency of the band-pass filter,
Q_{F} denotes a quality factor of the band-pass filter, and
H₀ denotes a gain of the band-pass filter at the resonance frequency;
a variance of the continuous white noise, a quality factor of the band-pass filter, a resonance frequency of the band-pass filter, and a gain of the band-pass filter at the resonance frequency are chosen so that the variance of the filtered noise, given by the relation

$${P}_{1} ( x ( t ) ) = \frac{2 π {f}_{0} {H}_{0}^{2}}{2 {Q}_{F}} {Q}_{1} ( w ( t ) ) ,$$

is greater than or equal to the sum of the squares of the amplitudes of the components of said Fourier series in the bandwidth of the filter;
the state propagation model is calculated by means of an estimation module, the components of the state vector of the state propagation model being components of a state vector of a Kalman filter implemented in the estimation module and having at least one other component formed from an inertial measurement data determined based on the measurements performed by said gyrometer, the filtered noise being calculated within the Kalman filter;
the method comprises a step of discretizing the band-pass filter, the propagation model representing the band-pass filter after its discretization;
a resonance frequency of the band-pass filter is chosen at the center of said bandwidth;
the gyrometer is configured so that the angular position of the vibrating element varies as a function of a control angular speed imposed on this vibrating element and/or an angular rotation speed of the housing in an inertial reference frame;
at least two Fourier series decompositions are provided for at least two different angular rotation speeds of the housing, said bandwidth being selected based on all the provided Fourier series decompositions.

The invention also relates to a gyrometric device comprising a calculator and a gyrometer, the gyrometer comprising a housing and a vibrating element able to vibrate relative to the housing, the gyrometric device being configured to implement the steps of the navigation data determination method.

According to another advantageous aspect of the invention, the gyrometric device comprises an inertial unit comprising said gyrometer, and:
the gyrometric device further comprises a sensor configured to provide the calculator with additional data comprising attitude and/or speed and/or position and/or acceleration data, and/or
the inertial unit is further configured to provide data relating to the state of motion of the gyrometer housing,
the gyrometric device being configured to determine hybridized navigation data.

### BRIEF DESCRIPTION OF THE SEVERAL VIEWS OF THE DRAWINGS

The invention will become clearer upon reading the following description, given solely by way of non-limiting example, and made with reference to the drawings wherein:

FIG. 1 is a schematic representation of a gyrometric device according to a first embodiment of the invention;

FIG. 2 is a partial schematic representation of a particular gyrometer of the gyrometric device shown in FIG. 1;

FIG. 3 is a representation of the sensor reference frame and the wave reference frame of the gyrometer shown in FIG. 2;

FIG. 4 is a flowchart representation of the navigation data determination method according to the invention;

FIG. 5 represents an amplitude spectrum of a Fourier series decomposition of an example of harmonic-type defect (curve C1) and the desired power spectral density curve of a filtered noise (curve C2) as a function of frequency; and

FIG. 6 represents curves C1 and C2 shown in FIG. 5 and the power spectral density curve of a filtered noise obtained with a 4^{th} order band-pass filter (curve C3) as a function of frequency.

### DETAILED DESCRIPTION OF THE DISCLOSURE

The invention relates to a method 100 for determining navigation data 5 by means of a gyrometric device 7 comprising a gyrometer 10 and a calculator 15.

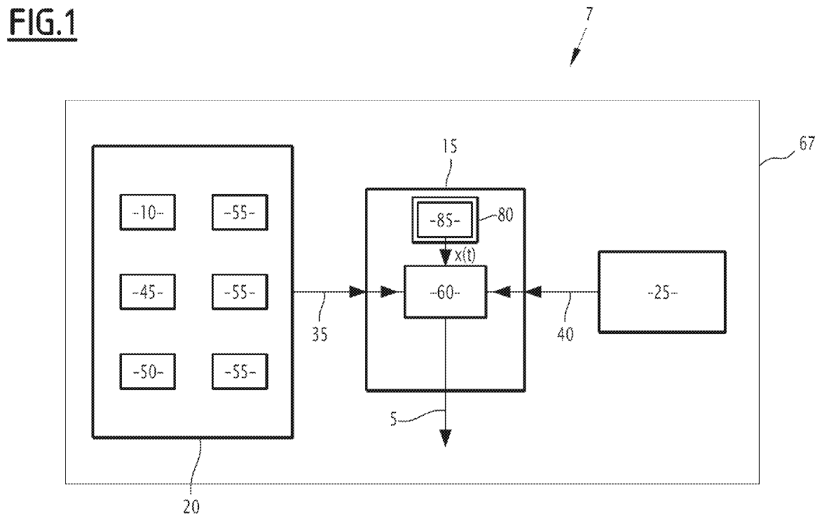

In a first embodiment described with reference to FIG. 1, the gyrometric device 7 is in the form of a hybridized inertial unit, the hybridized inertial unit comprising an inertial unit 20 comprising the gyrometer 10, the calculator 15, which in this case is a data hybridization calculator of inertial measurement data 35 provided by the inertial unit 20 and of additional data 40, and optionally a sensor 25 providing the additional data 40.

The hybridized inertial unit, visible in FIG. 1, equips a vehicle (not shown), such as an aircraft or a land vehicle.

The architecture of the hybridized inertial unit presented in FIG. 1 is provided as an illustrative and non-limiting example.

The inertial unit 20 comprises in this embodiment the gyrometer 10.

The inertial unit 20 may comprise one or more complementary gyrometers, for example, two other complementary gyrometers 45 and 50.

Each gyrometer 10, 45, 50 is in this case configured to provide either directly to the calculator 15, or to a calculator of the inertial unit 20, angular speed measurements of the vehicle relative to a respective sensitive axis.

If applicable, the respective sensitive axes of the three gyrometers 10, 45, 50 are preferably non-coplanar.

The inertial unit 20 may also comprise one or more accelerometers 55.

Each accelerometer 55 is configured to provide either directly to the calculator 15, or to the calculator of the inertial unit 20, linear acceleration measurements of the vehicle relative to a respective sensitive axis.

The calculator 15 is therefore configured to receive inertial measurement data 35.

The inertial measurement data 35 comprise measurement data provided directly by the gyrometer 10 or formed from these measurement data.

In a particular embodiment, the inertial measurement data 35 comprise angular speed measurement data relative to the sensitive axis of the gyrometer 10.

In addition or alternatively, the inertial measurement data 35 comprise attitude, speed, and position data calculated by the inertial unit 20, particularly from the angular speed measured by the gyrometer 10.

In this first embodiment, the calculator 15 is also configured to receive the additional data 40.

In the example shown in FIG. 1, the additional data 40 are provided by the sensor 25.

The sensor 25 is therefore capable of providing additional data 40 to the calculator 15, the additional data 40 comprising linear and/or angular acceleration data and/or linear and/or angular speed data and/or position and/or attitude data.

The sensor 25 is, for example, an altimeter, an odometer, or a receiver of additional data 40, such as a satellite positioning receiver, such as a GNSS (Global Navigation Satellite System) signal receiver from a plurality of navigation satellites of one or more GNSS systems, for example, the GPS system (Global Positioning System).

In the case where the sensor 25 is a satellite positioning receiver, the additional data 40 are therefore GNSS measurement data and they may comprise geographic positioning coordinates, such as distances between the position of the receiver and the positions of the satellites of the GNSS system(s), a latitude, a longitude, and/or an altitude and/or an attitude data in heading, roll, and/or pitch and/or at least one linear speed data.

In an alternative or complementary embodiment of the embodiment shown in FIG. 1, the additional data 40 are data relating to a state of motion of a housing 57 of the gyrometer 10, which will be described later, particularly data relating to the detection of immobility of the housing 57. In this case, the additional data 40 can be obtained from measurements made by the inertial unit 20 itself.

The inertial unit 20 comprises in this case a module for determining the additional data 40, this module (not shown) receiving at the input measurement data from the inertial unit 20 and providing at the output the additional data 40.

In the first embodiment, the calculator 15 is configured to determine, and possibly provide on an output of the gyrometric device 7, at least one navigation data 5, which is hybridized navigation data, taking into account the measurement errors inherent in the inertial measurement data 35 provided by the inertial unit 20, for example, errors on the attitude, speed, and position of the housing due to errors of the gyrometer 10, possibly taking into account defects of the sensor 25.

For example, in the case where the sensor 25 is a satellite positioning receiver, the defects of the sensor 25 comprise defects of the GNSS signal transmission space segment and/or defects due to the propagation of these signals in the atmosphere and/or material defects of the satellite positioning receiver.

To this end, the calculator 15 receives the inertial measurement data 35 and the additional data 40.

The calculator 15 comprises an estimation module 60 and a modeling module 80.

The calculator 15 comprises, for example, a hardware component (such as a programmable logic circuit of the FPGA (Field-Programmable Gate Array) type and/or a software component. In the latter case, the software component is, for example, implemented by a computer comprising at least one processor and a random-access memory.

In the example of FIG. 1, the calculator 15 is integrated into a main housing 67 of the hybridized inertial unit, wherein the inertial unit 20 and the sensor 25 are also placed.

Alternatively, the gyrometric device 7 is made in a distributed manner, the calculator 15 being then distant from the main housing 67, or even distant from the vehicle equipped with the hybridized inertial unit.

In the first embodiment, the estimation module 60 is configured to receive the inertial measurement data 35 as well as the additional data 40 from the sensor 25.

The estimation module 60 comprises, for example, a Kalman filter, whose state vector represents one or more errors made on the inertial measurement data 35 provided by the inertial unit 20 and/or on the measurement data 40 provided by the sensor 25.

In the first embodiment, the estimation module 60 also receives a model of the error made on the gyrometric measurements performed by the gyrometer 10, particularly on the angular speed measured according to the sensitive axis of the gyrometer 10, this model being provided by the modeling module 80 and modeling at least one harmonic defect of the gyrometer 10.

In a particular embodiment, the modeling module 80 is implemented as an integral part of the estimation module 60, as will be described later, the estimation module 60 being then configured to determine the error model and simultaneously provide at least one hybridized navigation data 5.

The modeling module 80 is configured to exchange data with the gyrometer 10 and to provide the model of the error made on the inertial measurement data 35, for example in particular on the angular speed measured according to the sensitive axis of the gyrometer 10 according to the invention, as will be described later.

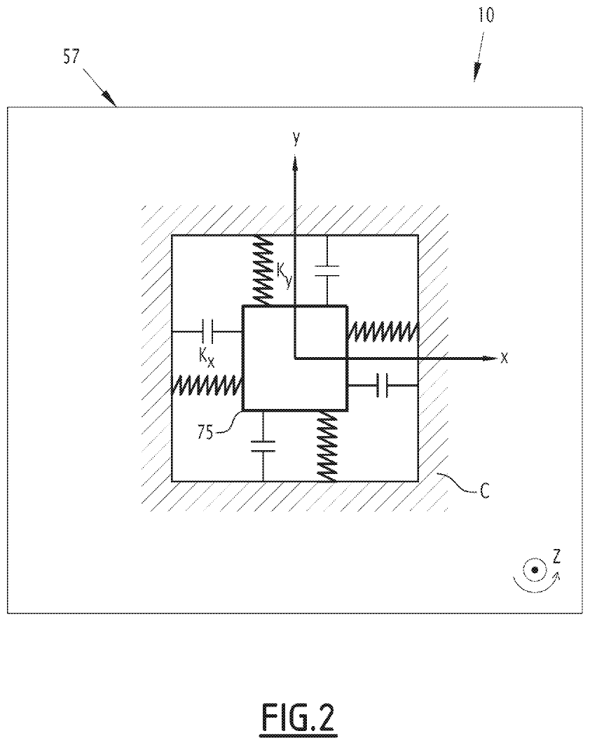

An example of gyrometer 10 is schematically represented in FIG. 2. The excitation and control means of the gyrometer 10 are not shown in this figure.

The gyrometer 10 is configured to provide a measured angular speed Ω_{Z,mes}(t), which estimates a real instantaneous angular speed Ω_{Z,reel}(t) of the housing 57 of the gyrometer 10 relative to its sensitive axis, noted Z hereafter.

To this end, the gyrometer 10 includes the housing 57 and a vibrating element 75 capable of vibrating relative to the housing 57.

The gyrometer 10 is configured to exchange data with the modeling module 80 of the calculator 15.

The gyrometer 10 is, for example, made in the form of a microelectromechanical system (“Micro Electromechanical Sensor” or MEMS).

The gyrometer 10 is, for example, an axisymmetric gyrometer.

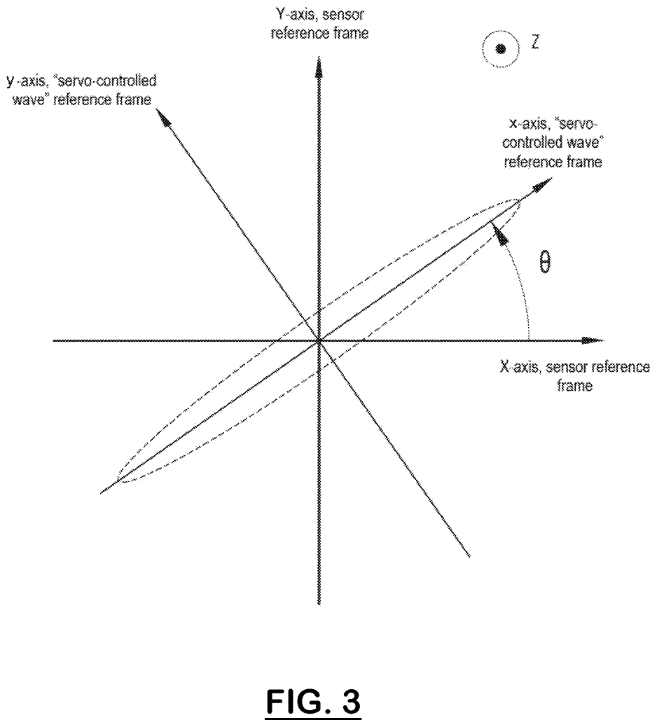

Three axes X, Y, Z of the XYZ space reference frame of a reference frame linked to the housing 57 of the gyrometer 10, called hereafter “sensor reference frame XYZ” are represented in FIG. 3.

The vibrating element 75 is capable of vibrating in the XY plane of the sensor reference frame XY in two directions x and y.

Hereafter, we consider that the direction x is the drive mode direction and the direction y is the detection mode direction of the gyrometer 10.

Hereafter, the xyZ reference frame linked to the drive mode and detection mode directions is called “wave reference frame xyZ”.

The position of the wave reference frame xyZ relative to the sensor reference frame XYZ is indicated by the angular coordinate θ_{z} visible in FIG. 3.

The instantaneous angular speed measured Ω_{z,mes}(t) measured by the gyrometer 10 can notably be deduced from the angular coordinate θ_{z} characterizing the position of the wave reference frame xyZ relative to the sensor reference frame XYZ.

The instantaneous angular speed measured Ω_{Z,mes}(t) is affected by errors intrinsically linked to the design of the gyrometer 10.

In particular, it can generally be considered that the real instantaneous angular speed Ω_{Z,reel}(t) of the housing 57 and the angular speed measured Ω_{Z,mes}(t) measured by the gyrometer 10 are linked by a relation of the form:

$${Ω}_{Z , mes} ( t ) = ( 1 + {ε}_{Z} ( t ) ) {Ω}_{Z , reel} ( t ) + {D}_{Z} ( t ) \qquad ( 1 )$$

wherein ε_{Z}(t) and D_{Z}(t) are error terms induced by the intrinsic defects of the gyrometer 10.

The error terms ε_{Z}(t) and D_{Z}(t) can thus model defects respectively of scale factor type and drift type.

The error terms ε_{Z}(t) and D_{Z}(t) are generally variable over time.

One of the error terms ε_{Z}(t) and D_{Z}(t) or both terms simultaneously can comprise, or even consist of harmonic-type error terms δ_{Z}(t).

By harmonic-type error δ_{z}(t), we mean in the present application an error that is a function of the angular coordinate θ_{z} characterizing the position of the wave reference frame xyZ relative to the sensor reference frame XYZ and which can be modeled by a periodic function of the angular coordinate θ_{z}.

Consequently, a harmonic-type error δ_{z}(t) can also be modeled by a Fourier series according to the following equation 2:

$${δ}_{Z} ( {θ}_{Z} ( t ) ) = {\sum }_{i = 1}^{n} {A}_{{i}_{Z}} * cos ( {θ}_{Z} ( t ) * i + {φ}_{{i}_{Z}} ) \qquad ( 2 )$$

The modeling module 80 is therefore more particularly configured to determine a modeling of at least one harmonic-type error δ_{z}(t) of the gyrometer 10.

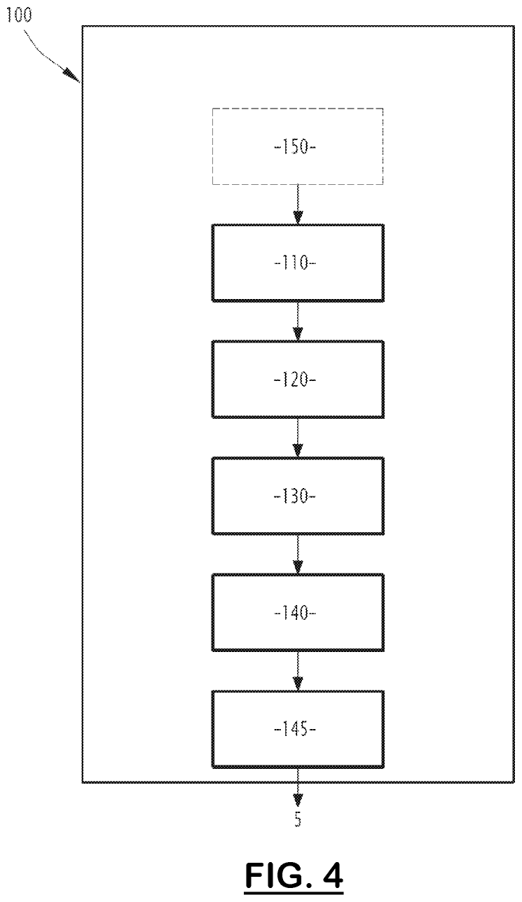

The method 100 for determining navigation data 5 according to the invention will now be described with reference to FIG. 4.

The method 100 comprises:
a) providing 110 the Fourier series decomposition of the harmonic-type error term δ_{Z}(t) modeling a defect of the gyrometer 10, this defect being a function of the angular position θ_{Z} of the vibrating element 75 in the XYZ reference frame linked to the housing 57;
b) selecting 120 at least one frequency range based on a plurality of amplitudes A_{iZ} and respective frequencies fᵢ of said Fourier series;
c) determining 130 a band-pass filter and continuous white noise w(t) to be provided at the input of the band-pass filter to obtain filtered noise x(t) at the output of the band-pass filter; and
d) determining 140 a model of the error made on a measurement performed with the gyrometer 10 based on said filtered noise x (t), and
e) based on said determined model and at least one measurement performed by the gyrometer 10, determining 145 navigation data 5.

The navigation data 5 comprise for example:
hybridized navigation data 5, the method 100 comprising in this case the receipt by the calculator 15 of additional data 40, which comprise linear and/or angular acceleration data and/or linear and/or angular speed data and/or position and/or attitude data 40 provided by the additional data sensor 25 and/or data relating to the state of motion of the housing 57 of the gyrometer 10, and the use of these additional data 40 for the described determination of said hybridized navigation data 5, and/or
inertial navigation data 5 and respective error standard deviations, these data and these standard deviations being formed from the measurement performed with the gyrometer 10 and a standard deviation of an error made on this measurement determined by means of the error model provided by the modeling module 80.

We first describe a first embodiment of the method 100 wherein the navigation data 5 are hybridized navigation data.

In this case, the method 100 can be implemented by means of the gyrometric device 7 according to the first embodiment described above.

The provision 110 of the Fourier series decomposition to the modeling module 80 comprises the provision of the harmonic amplitudes A_{iZ} corresponding to the different harmonics of the Fourier series decomposition of equation 2, as well as the provision of the respective frequencies fᵢ.

The Fourier series provided at step 110 comprises a finite number of harmonics, for example, with respective frequencies fᵢ below an upper threshold frequency beyond which the harmonic error terms can be considered negligible. For example, if a control angular pulsation is imposed on the gyrometer 10, the threshold frequency can be chosen based on this control angular pulsation.

The harmonic amplitudes A_{iZ} can be evaluated from data provided by the manufacturer of the gyrometer 10 and/or during a prior calibration step 150 of the gyrometer 10.

The calibration step 150 can comprise one or more series of angular speed measurements during which the angular speed of the gyrometer 10 according to the sensitive axis Z is imposed at a known and measured setpoint value, the error made on the measured angular speed being, for each measurement, evaluated by comparing the measured angular speed and the setpoint value.

The Fourier series decomposition can then be deduced from the series of errors thus evaluated.

The harmonic amplitudes A_{iZ} of the harmonics of this Fourier series cannot be strictly constant over time, particularly due to temperature variations of the gyrometer 10.

In this case, it is possible to observe the evolution of these harmonic amplitudes A_{iZ} during the calibration step 150 of the gyrometer 10 by imposing for the different series of measurements varied operating conditions, these operating conditions being representative of the possible temperature variations of the gyrometer 10.

At least one, or even each of the harmonic amplitudes A_{iZ} provided at the provision step 110 can in this case be an upper bound of the respective amplitudes observed during the different series of measurements of the calibration step 150.

The frequencies fᵢ of the harmonic terms are provided based on a temporal evolution law of the angular coordinate θ_{Z}.

In particular, a control angular pulsation ω_{com} of rotation of the wave reference frame relative to the sensitive axis Z of the sensor reference frame can be imposed on the vibrating element 75. In this case, the frequencies fᵢ of the harmonic terms are equal to the division by 2π of the product of the integer i characterizing the respective harmonic and the control angular pulsation ω_{com}.

Alternatively or in addition, the angular coordinate θ_{Z} can evolve due to a rotational movement of the vehicle carrying the gyrometer 10 relative to the sensitive axis Z, the frequencies fᵢ of the harmonic terms being then shifted more or less significantly relative to respective reference frequencies depending on the state of motion of the vehicle.

In this case, several Fourier series, or even frequency ranges fᵢ of the harmonic terms can be provided as input to the modeling module 80, in order to anticipate the shift of the terms of the Fourier series decomposition of the harmonic-type error δ_{Z}(t) during the subsequent movement of the vehicle.

During the provision step 110, the modeling module 80 therefore receives at least one set of characteristic data of an amplitude spectrum of the Fourier series.

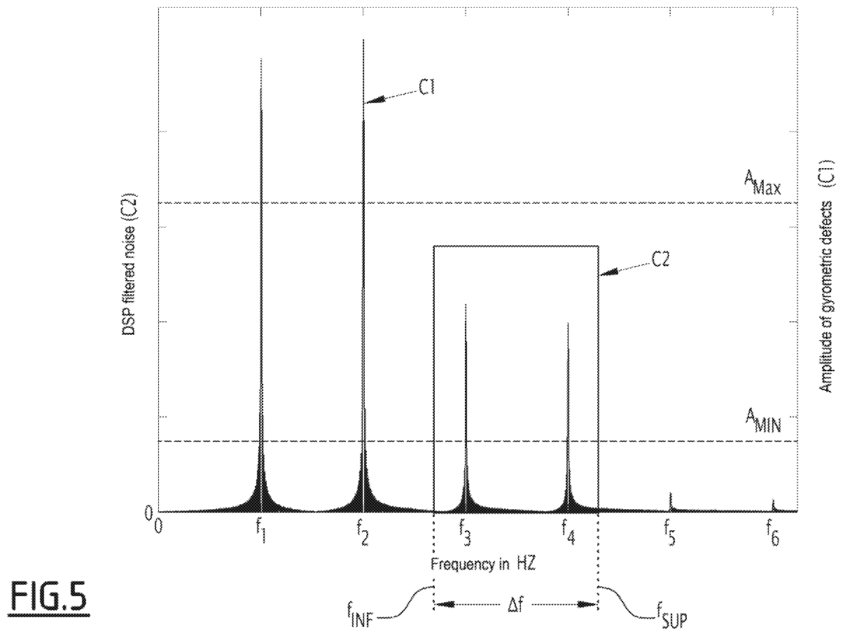

This amplitude spectrum is represented by curve C1 in FIG. 5.

During the selection step 120, at least one frequency range Δf is selected by the modeling module 80 based on the plurality of harmonic amplitudes Δ_{iZ} and respective frequencies fᵢ provided for said Fourier series.

The selection step 120 can be made based on one or more predetermined criteria.

For example, the frequency range Δf can be chosen to encompass all frequencies whose respective amplitude Δ_{iZ} is greater than a lower threshold value Aₘᵢₙ and/or less than an upper threshold value Aₘₐₓ.

In the example shown in FIG. 5, the frequency range Δf is thus chosen so that the modeling of the harmonic-type error δ_{Z}(t) comprises the modeling of harmonics of ranks 3 and 4.

In this example, harmonics of ranks 1 and 2, with particularly high amplitude, can in this case be managed by means of a second frequency range Δf_compl_1, which will be selected in a second iteration of the selection step 120 based on different criteria.

In this example, harmonics of ranks 5 and 6 can be neglected due to their low amplitudes.

The predetermined criteria can be chosen based on the desired modeling accuracy and/or the cost in terms of time and memory of the method 100.

The fineness of the division of the distribution of the different components of the Fourier series to be modeled into one or more frequency ranges Δf depends on the chosen predetermined criteria.

Once the frequency range Δf is selected, the modeling module 80 determines at the determination step 130 the band-pass filter to be used and the continuous white noise w(t) to be provided at the input of this band-pass filter to form the filtered white noise x(t) at the output of this band-pass filter.

The bandwidth of the filter contains the frequency range Δf.

The bandwidth of the filter contains among the frequencies fᵢ of the Fourier series only those that are in the frequency range Δf. In other words, the bandwidth of the filter contains no frequency f₁ of the Fourier series not belonging to the frequency range Δf.

Notably, the bandwidth of the filter, whose lower and upper cutoff frequencies are noted f_{inf} and fₛᵤₚ hereafter, can be equal to the frequency range Δf.

A transfer function of the band-pass filter and the continuous white noise w(t) are chosen so that in the bandwidth [f_{inf}, fₛᵤₚ], the integral of the power spectral density DSP(f) of the filtered noise x(t) is greater than or equal to the sum of the squares of the harmonic amplitudes A_{iZ} of the Fourier series in this same bandwidth.

The mathematical link between the continuous white noise w(t), the transfer function of the band-pass filter, and the power spectral density of the filtered noise is generally known to those skilled in the art for each type of filter.

In a particular embodiment, in the bandwidth [f_{inf}, fₛᵤₚ], the integral of the power spectral density DSP(f) of the filtered noise x(t) is equal to the sum of the squares of the harmonic amplitudes A_{iZ} of the Fourier series in this same bandwidth, according to equation 3:

$${\int }_{{f}_{inf}}^{{f}_{sup}} D S P ( f ) d f = {\sum }_{{f}_{i} ∈ Δ f} {A}_{{i}_{Z}}^{2} \qquad ( 3 )$$

An example of the desired power spectral density in the case of the example shown in FIG. 5 is represented by curve C2 in FIG. 5.

The band-pass filter is a filter of order N greater than or equal to 2.

The order N of the filter can be chosen based on the required selectivity and/or a limit on the cost in terms of time and/or memory of the method 100.

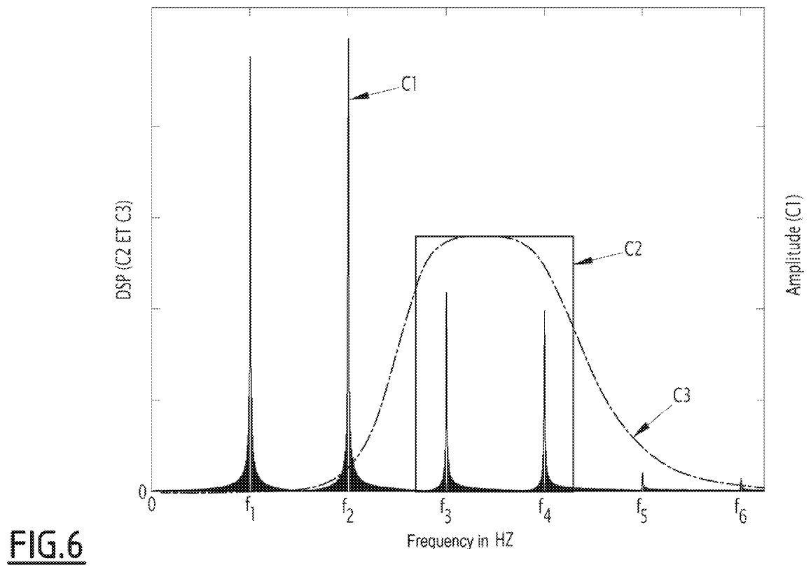

An example of the power spectral density actually obtained with a 4^{th} order band-pass filter chosen based on the example shown in FIG. 5 is represented on curve C3 in FIG. 6.

The modeling module 80 then proceeds to the determination step 140 of the model of the error made on the angular speed measured Ω_{Z,mes}(t) with the gyrometer 10 based on the filtered noise x(t) obtained at the output of the band-pass filter determined in response to the continuous white noise w(t).

For simplicity, we describe hereafter an embodiment of the determination step 130 of the band-pass filter and the continuous white noise w(t) as well as the determination step 140 of the model of the error made in the particular case of a 2^{nd} order band-pass filter.

The generalization to an N^{th} order filter will be carried out without difficulty.

In the case of a 2^{nd} order filter, the frequency representation W(f) of the continuous white noise at the input of the filter and the frequency representation X(f) of the filtered noise are linked by the transfer function of the filter according to the following equation, written in complex notation:

$$\underline{X ( f )} = {H}_{0} \frac{\frac{{f}_{0}}{{Q}_{F}} j f}{{( j f )}^{2} + \frac{{f}_{0}}{{Q}_{F}} j f + {( {f}_{0} )}^{2}} \underline{W ( f )} \qquad ( 4 )$$

wherein f₀ is the resonance frequency of the filter, H₀ is its amplitude gain at the resonance frequency f₀, Q_{F} is the quality factor of the filter, j denotes the imaginary unit, i.e., the complex number such that j²=−1

The transfer function of the band-pass filter can be represented by means of a state propagation model 85 implemented in the modeling module 80.

Notably, if we denote Y(f) the frequency representation of an auxiliary variable y(t) and u(t) the state vector given by the following equation:

$$u ( t ) = ( \begin{matrix}y ( t ) \\ \frac{dy}{dt}\end{matrix} ) , \qquad ( 5 )$$

the band-pass filter can be represented by the state propagation model 85 as follows:

$$\{ \begin{matrix}\dot{u} ( t ) = [ \begin{matrix}0 & 1 \\ - {( 2 π {f}_{0} )}^{2} & - \frac{2 π {f}_{0}}{{Q}_{F}}\end{matrix} ] u ( t ) + [ \begin{matrix}0 \\ 1\end{matrix} ] w ( t ) = A u ( t ) + B w ( t ) \\ x ( t ) = [ \begin{matrix}0 & {H}_{0} \frac{2 π {f}_{0}}{{Q}_{F}}\end{matrix} ] u ( t ) = C u ( t )\end{matrix} \qquad ( 6 )$$

wherein u(t) is the state vector of the state propagation model 85, w(t) is the continuous white noise at the input of the band-pass filter, x(t) is the filtered noise obtained at the output of the band-pass filter, f₀ is the resonance frequency of the band-pass filter, Q_{F} is the quality factor of the band-pass filter, and H₀ is the gain of the band-pass filter at the resonance frequency f₀.

A calculation known to those skilled in the art from equation (6) indeed gives:

$$\underline{X ( f )} = {H}_{0} \frac{2 π {f}_{0}}{{Q}_{F}} j 2 π f Y ( f )$$

$$and \underline{Y ( f )} = \frac{1}{{( j 2 π f )}^{2} + \frac{2 π {f}_{0}}{{Q}_{F}} j 2 π f + {( 2 π {f}_{0} )}^{2}} \underline{W ( f )}$$

We thus find again equation (4).

The resonance frequency f₀ of the filter is for example chosen equal to the average of the extreme lower and upper frequencies f_{inf} and fₛᵤₚ.

The quality factor Q_{F} is chosen so that the bandwidth of the filter corresponds to [f_{inf}, fₛᵤₚ].

For the choice of the continuous white noise w (t) and the other characteristics of the band-pass filter, we can, for example, use the following equations:

In steady state, the evolution matrix A of the propagation model 85 satisfies the equation:

$$A P + P {A}^{T} + Q = 0 \qquad ( 7 )$$

wherein P denotes the covariance matrix of the state vector u and Q the variance matrix of the vector B w(t) with

$$B = ( \begin{matrix}0 \\ 1\end{matrix} ) .$$

By noting Q₁(w(t)) or more simply, Q₁, the variance of the continuous white noise w(t), the variance matrix Q satisfies

$$Q = [ \begin{matrix}0 & 0 \\ 0 & {Q}_{1}\end{matrix} ] .$$

Equation 7 can be written:

$$( 8 )$$

$$[ \begin{matrix}0 & 1 \\ - {( 2 π {f}_{0} )}^{2} & - \frac{2 π {f}_{0}}{{Q}_{F}}\end{matrix} ] [ \begin{matrix}{p}_{11} & {p}_{12} \\ {p}_{12} & {p}_{22}\end{matrix} ] + [ \begin{matrix}{p}_{11} & {p}_{12} \\ {p}_{12} & {p}_{22}\end{matrix} ] [ \begin{matrix}0 & - {( 2 π {f}_{0} )}^{2} \\ 1 & - \frac{2 π {f}_{0}}{{Q}_{F}}\end{matrix} ] + [ \begin{matrix}0 & 0 \\ 0 & {Q}_{1}\end{matrix} ] = 0$$

So that the diagonal coefficients of the covariance matrix P satisfy:

$${p}_{22} = \frac{1}{2} \frac{{Q}_{F}}{2 π {f}_{0}} {Q}_{1}$$

$${p}_{11} = \frac{1}{2} \frac{{Q}_{F}}{{( 2 π {f}_{0} )}^{3}} {Q}_{1}$$

The variance P₁(x(t)) of the desired filtered noise at the output of the band-pass filter represented by the state propagation model 85 is thus in this case linked to the variance Q₁ of the continuous white noise at the input of the band-pass filter by the following equation:

$$( 9 )$$

$${P}_{1} ( x ( t ) ) = {CPC}^{T} = [ \begin{matrix}0 & {H}_{0} \frac{2 π {f}_{0}}{{Q}_{F}}\end{matrix} ] [ \begin{matrix}\frac{1}{2} \frac{{Q}_{F}}{{( 2 π {f}_{0} )}^{3}} {Q}_{1} & 0 \\ 0 & \frac{1}{2} \frac{{Q}_{F}}{2 π {f}_{0}} {Q}_{1}\end{matrix} ] [ \begin{matrix}0 \\ {H}_{0} \frac{2 π {f}_{0}}{{Q}_{F}}\end{matrix} ] = \frac{{H}_{0}^{2}}{2} \frac{2 π {f}_{0}}{{Q}_{F}} {Q}_{1} ( w ( t ) )$$

Advantageously, the parameters of the band-pass filter are chosen so that the integral of the power spectral density DSP(f) of the filtered noise x(t) outside the bandwidth is negligible compared to the integral in the bandwidth. Thanks to this arrangement, the variance P₁(x(t)) of the filtered noise x(t) (which is mathematically equal to the integral of the power spectral density DSP(f) of the filtered noise x(t) for frequencies ranging from 0 to infinity) is very close to the integral of the power spectral density DSP(f) of the filtered noise x(t) in the bandwidth of the band-pass filter. Thus, the variance P₁(x(t)) of the desired filtered noise x(t) at the output of the band-pass filter is imposed by the fact that the integral of the power spectral density DSP(f) of the filtered noise x(t), in the bandwidth [f_{inf}, fₛᵤₚ] of the filter, must be greater than or equal to the sum of the squares of the amplitudes of the components of said Fourier series, in this same bandwidth.

It is therefore possible to choose the continuous white noise so that the variance P₁(x(t)) of the filtered noise x(t), given by the relation

$${P}_{1} ( x ( t ) ) = \frac{2 π {f}_{0} {H}_{0}^{2}}{2 {Q}_{F}} {Q}_{1} ( w ( t ) ) ,$$

is greater than or equal to the sum of the amplitudes of the components of said Fourier series, in the bandwidth [f_{inf}, fₛᵤₚ] of the filter.

The gain H₀ of the band-pass filter can be chosen arbitrarily beforehand.

In one embodiment, the band-pass filter determined at the determination step 130 is a continuous-time filter and this filter is discretized to form a discrete-time band-pass filter for its implementation in the form of the state propagation model 85 for the determination step 140 of the error model by the modeling module 80.

Once the state propagation model 85 is implemented by the modeling module 80, the modeling module 80 can provide at the output the filtered noise x(t), this filtered noise x(t) constituting in the selected frequency range Δf, the model of the error made on the measured angular speed Ω_{Z,mes}(t) sought.

This model is then provided to the estimation module 60.

In the particular case where the estimation module 60 implements a Kalman filter, the state propagation model 85 can be directly integrated into the Kalman filter of the estimation module 60. The components of the state vector of the state propagation model 85 are thus components of the state vector of the Kalman filter of the estimation module 60 and the filtered noise x(t) is calculated directly within the Kalman filter of the estimation module 60.

We describe hereafter this particular embodiment, in the particular case of a 2^{nd} order band-pass filter and in the case where we want to model the drift terms D_{Z} in equation

$${Ω}_{Z , mes} ( t ) = ( 1 + {ε}_{Z} ( t ) ) {Ω}_{Z , reel} ( t ) + {D}_{Z} ( t ) \qquad ( 10 )$$

In this case, the state vector of the Kalman filter of the estimation module 60 comprises the components y(t) and dy/dt of the state vector u of the state propagation model 85. It also comprises a component δ_{φ}, which constitutes an attitude error due to the integration of the error D_{Z}(t).

If we denote V(t) the vector consisting of these three components present in the state vector of the filter, V(t) is thus of the form

$$V ( t ) = ( \begin{matrix}δ φ \\ y ( t ) \\ \frac{dy}{dt}\end{matrix} ) .$$

In the Kalman filter of the estimation module 60, we can then use the following state propagation model for the vector V (t):

$$\dot{V} ( t ) = [ \begin{matrix}0 & 0 & {H}_{0} \frac{2 π {f}_{0}}{{Q}_{F}} \\ 0 & 0 & 1 \\ 0 & - {( 2 π {f}_{0} )}^{2} & - \frac{2 π {f}_{0}}{{Q}_{F}}\end{matrix} ] V ( t ) + [ \begin{matrix}0 \\ 0 \\ 1\end{matrix} ] w ( t )$$

Thus, the Kalman filter of the estimation module 60 performs the calculation of the term

$$[ \begin{matrix}0 & 0 & {H}_{0} \frac{2 π {f}_{0}}{{Q}_{F}} ]\end{matrix} V$$

and thus of the term

$$[ \begin{matrix}0 & {H}_{0} \frac{2 π {f}_{0}}{{Q}_{F}}\end{matrix} ] ( \begin{matrix}y ( t ) \\ \frac{dy}{dt}\end{matrix} )$$

which corresponds to the filtered noise x(t).

Once the error model is determined or simultaneously with this determination step 140, the estimation module 60 proceeds to the determination step 145 of the hybridized navigation data 5 based on the determined error model, the received additional data 40, and the inertial data 35, the hybridized navigation data 5 can then be provided on an output of the gyrometric device 7.

In a particular embodiment, the error model determined by the modeling module 80 is stored temporarily in an error model database.

In a second embodiment, the gyrometric device 7 comprises the gyrometer 10 and the calculator 15 but does not comprise a sensor 25.

In this case, the calculator 15 does not receive additional data 40 and is not configured to determine hybridized navigation data 5 but to determine inertial navigation data 5, these data comprising navigation data proper, such as attitude and/or linear and/or angular acceleration data, and/or linear and/or angular speed and/or position data, and respective error standard deviations, these data and these standard deviations being formed from the inertial measurement data 35 and the error model determined by the modeling module 80.

The calculator 15 therefore receives in this case the inertial measurement data 35, without receiving additional data 40.

In particular, in the second embodiment, the estimation module 60 is configured to receive the error model determined by the modeling module 80 and to calculate the standard deviation of the error made on the angular speed measured Ω_{Z,mes}(t) measured by the gyrometer 10 from this error model.

In a particular embodiment, the error model provided to the estimation module 60 is the variance of the filtered white noise x (t).

The standard deviation thus provided is notably an upper bound of the standard deviation of the error actually made on the angular speed measured Ω_{Z,mes}(t) measured by the gyrometer 10.

The gyrometric device 7 according to the second embodiment is configured to implement the method 100 according to a second embodiment, the navigation method then comprising:
1) the implementation of the provision step 110, selection step 120, determination step 130 of the band-pass filter, and determination step 140 of the error model described previously, and
2) the determination 145 of inertial navigation data 5 and respective standard deviations, these data and these standard deviations being formed from the measurement performed with the gyrometer 10 and the standard deviation of the error made on this measurement determined by means of the error model provided by the modeling module 80.

The at least one navigation data 5 can then be provided on an output of the gyrometric device 7.

The first and second embodiments can be combined.

Regardless of the embodiment, the modeling module 80 allows real-time implementation of the error model within the estimation module 60, notably by implementing a Kalman filter in the estimation module 60, and thus achieving precise inertial navigation with lower-cost sensors.

Moreover, the method 100 according to the invention is inexpensive in terms of time and memory, so that the calculator 15 can comprise a processor of low financial cost and/or low energy consumption.

Finally, in the case where the band-pass filter is discretized, the method 100 according to the invention makes it possible to truly model zero-mean states without low-frequency aliasing.

1. A method for determining navigation data by means of a gyrometric device comprising a calculator and a gyrometer, the gyrometer comprising a housing and a vibrating element, able to vibrate relative to the housing, the method comprising:
a) providing the calculator with at least one Fourier series of an error term modeling at least one defect of the gyrometer, said defect being a function of an angular position of the vibrating element in a reference frame linked to the housing;
b) selecting at least one frequency range based on a plurality of amplitudes and respective frequencies of said Fourier series;
c) determining a band-pass filter and continuous white noise to be provided at the input of the band-pass filter to obtain filtered noise at the output of the band-pass filter, such that:
a bandwidth of the filter contains said frequency range and contains none of the respective frequencies of said Fourier series that are not in said frequency range, and
in the bandwidth, the integral of a power spectral density of the filtered noise is greater than or equal to the sum of the squares of the amplitudes of the components of said Fourier series in this same bandwidth;
d) determining a model of the error made on a measurement performed with the gyrometer based on said filtered noise; and
e) determining the navigation data based on said determined model and at least one measurement performed by the gyrometer.

2. The method according to claim 1, wherein the navigation data comprise:
hybridized navigation data, the method comprising in this case the receipt by the calculator of additional data, which comprise acceleration and/or speed and/or position and/or attitude data provided by an additional data sensor and/or data relating to the state of motion of the housing of the gyrometer, and the use of these additional data to determine said hybridized navigation data, and/or
inertial navigation data and respective error standard deviations, these data and these standard deviations being formed from the measurement performed with the gyrometer and a standard deviation of an error made on this measurement determined by means of said determined model.

3. The method according to claim 1, wherein the band-pass filter and the continuous white noise are chosen so that, in the bandwidth, the integral of the power spectral density of the filtered noise is equal to the sum of the squares of the amplitudes of the components of said Fourier series in this same bandwidth.

4. The method according to claim 1, wherein the determination of said error model comprises the implementation of the band-pass filter by means of a state propagation model and the determination of the filtered noise and/or a variance of the filtered noise.

5. The method according to claim 4, wherein the state propagation model is represented by the following model:
$$\{ \begin{matrix}\dot{u} ( t ) = [ \begin{matrix}0 & 1 \\ - {( 2 π {f}_{0} )}^{2} & - \frac{2 π {f}_{0}}{{Q}_{F}}\end{matrix} ] u ( t ) + [ \begin{matrix}0 \\ 1\end{matrix} ] w ( t ) \\ x ( t ) = [ \begin{matrix}0 & {H}_{0} \frac{2 π {f}_{0}}{{Q}_{F}}\end{matrix} ] u ( t )\end{matrix}$$
wherein:
u(t) denotes a 2-dimensional state vector of the state propagation model,
w(t) denotes the continuous white noise at the input of the band-pass filter,
x(t) denotes the filtered noise obtained at the output of the band-pass filter,
f₀ denotes a resonance frequency of the band-pass filter,
Q_{F} denotes a quality factor of the band-pass filter, and
H₀ denotes a gain of the band-pass filter at the resonance frequency.

6. The method according to claim 5, wherein a variance denoted Q₁(w(t)) of the continuous white noise w(t), the quality factor Q_{F} of the band-pass filter, the resonance frequency f₀ of the band-pass filter, and the gain H₀ of the band-pass filter at the resonance frequency f₀ are chosen so that the variance denoted P₁(x(t)) of the filtered noise, given by the relation
$${P}_{1} ( x ( t ) ) = \frac{2 π {f}_{0} {H}_{0}^{2}}{2 {Q}_{F}} {Q}_{1} ( w ( t ) ) ,$$
is greater than or equal to the sum of the squares of the amplitudes of the components of said Fourier series in the bandwidth of the filter.

7. The method according to claim 4, wherein the state propagation model is calculated by means of an estimation module, the components of the state vector of the state propagation model being components of a state vector of a Kalman filter implemented in the estimation module and having at least one other component formed from an inertial measurement data determined based on the measurements performed by said gyrometer, the filtered noise x(t) being calculated within the Kalman filter.

8. The method according to claim 4, comprising a step of discretizing the band-pass filter, the propagation model representing the band-pass filter after its discretization.

9. The method according to claim 1, wherein a resonance frequency of the band-pass filter is chosen at the center of said bandwidth.

10. The method according to claim 1, wherein the gyrometer is configured so that the angular position of the vibrating element varies as a function of a control angular speed imposed on this vibrating element and/or an angular rotation speed of the housing in an inertial reference frame.

11. The method according to claim 10, wherein at least two Fourier series decompositions are provided for at least two different angular rotation speeds of the housing, said bandwidth being selected based on all the provided Fourier series decompositions.

12. A gyrometric device comprising a calculator and a gyrometer, the gyrometer comprising a housing and a vibrating element, able to vibrate relative to the housing, the gyrometric device being configured to implement the steps of the method for determining navigation data according to claim 1.

13. The gyrometric device according to claim 12 comprising an inertial unit comprising said gyrometer, wherein:
the gyrometric device further comprises a sensor configured to provide the calculator with additional data comprising attitude and/or speed and/or position and/or acceleration data, and/or
the inertial unit is further configured to provide data relating to the state of motion of the housing of the gyrometer,
the gyrometric device being configured to determine hybridized navigation data.
